(19) United States
(12) Patent Application Publication
(10) Pub. No.: US 2006/0190517 A1
(43) Pub. Date: Aug. 24, 2006

(54) Techniques for transposition of a matrix arranged in a memory as multiple items per word

(76) Inventor: Miguel A. Guerrero, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/050,369

(22) Filed: Feb. 2, 2005

(51) Int. Cl. G06F 7/38

(52) U.S. Cl. 708/514

(57) ABSTRACT

A system, apparatus, method and article to perform transposition of a matrix arranged in memory as multiple items per word are described. The apparatus may include a media processing node to process media information. The media processing node may include a memory to store the media information as a matrix of items of media information and a transposing element to transpose the items of media information and to store transposed items of media information in the memory. Other embodiments are described and claimed.

### BACKGROUND

Media processing applications, such as image or video processing applications may involve performance demanding operations such as compressing/decompressing and filtering. Some media processing applications may involve the manipulation of multi-dimensional signals. For example, image and video processing operations may require filtering two-dimensional (2D) arrays of elements first in the horizontal direction and then in the vertical direction. When a filtering process is required to be performed in orthogonal directions, it may be important to improve the reading and writing of data. Accordingly, there may be a need for improved media processing techniques implemented by a system or within a network.

### BRIEF DESCRIPTION OF THE DRAWINGS

FIG. 1 illustrates a block diagram of a system in accordance with one embodiment.

FIG. 2 illustrates a logic diagram in accordance with one embodiment.

FIG. 3 illustrates a matrix in accordance with one embodiment.

FIG. 4 illustrates a matrix in accordance with one embodiment.

FIG. 5 illustrates a transposed matrix in accordance with one embodiment.

FIG. 6 illustrates a matrix in accordance with one embodiment.

FIG. 7 illustrates a transposed matrix in accordance with one embodiment.

FIG. 8 illustrates a transposed matrix in accordance with one embodiment.

FIG. 9 illustrates a matrix and a transposed matrix in accordance with one embodiment.

FIG. 10 illustrates a matrix and transposed matrix in accordance with one embodiment.

FIG. 11 illustrates a matrix and a transposed matrix in accordance with one embodiment.

### DETAILED DESCRIPTION

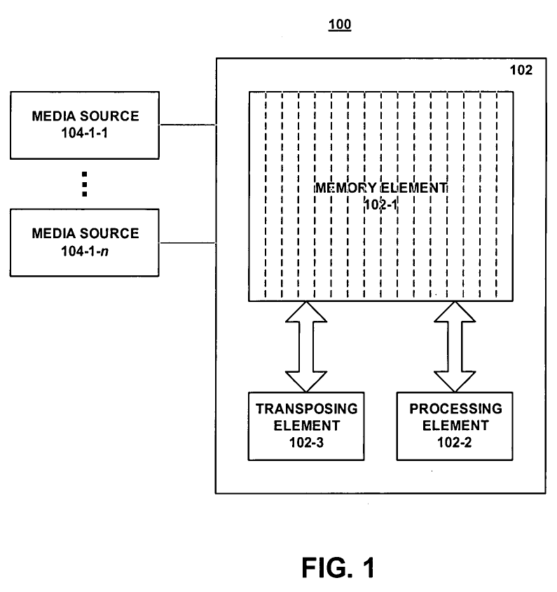

FIG. 1 illustrates a block diagram of a system 100. In one embodiment, for example, the system 100 may comprise a communication system having multiple nodes. A node may comprise any physical or logical entity for communicating information in the system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation. The embodiments are not limited in this context.

In various embodiments, a node may comprise, or be implemented as, a computer system, a computer sub-system, a computer, a workstation, a terminal, a server, a personal computer (PC), a laptop, an ultra-laptop, a handheld computer, a personal digital assistant (PDA), a set top box (STB), a telephone, a cellular telephone, a handset, an interface, an input/output (I/O) device (e.g., keyboard, mouse, display, printer), a router, a hub, a gateway, a bridge, a switch, a microprocessor, an integrated circuit, a programmable logic device (PLD), a digital signal processor (DSP), a processor, a circuit, a logic gate, a register, a microprocessor, an integrated circuit, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

In various embodiments, the nodes of system 100 may communicate, manage, or process information in accordance with one or more protocols. A protocol may comprise a set of predefined rules or instructions for managing communication among nodes. A protocol may be defined by one or more standards as promulgated by a standards organization, such as the Internet Engineering Task Force (IETF), International Telecommunications Union (ITU), the International Organization for Standardization (ISO), the International Electrotechnical Commission (IEC), the Institute of Electrical and Electronics Engineers (IEEE), and so forth. In one embodiment, for example, system 100 may be arranged to operate in accordance with standards for media processing, such as the ITU/IEC H.263 standard, Video Coding for Low Bitrate Communication, ITU-T Recommendation H.263v3, published November 2000 and the ITU/IEC H.264 standard, Video Coding for Very Low Bit Rate Communication, ITU-T Recommendation H.264, published May 2003. The embodiments are not limited in this context.

As shown in FIG. 1, the system 100 may comprise a media processing node 102. In various embodiments, the media processing node 102 may be arranged to process one or more types of information, such as media information. Media information generally may refer to any data representing content meant for a user, such as image information, video information, graphical information, audio information, voice information, textual information, numerical information, alphanumeric symbols, character symbols, and so forth. The embodiments are not limited in this context.

The media information may also include control information. Control information generally may refer to any data representing commands, instructions or control words meant for an automated system. For example, control information may be used to route media information through a system, or instruct a node to process the media information in a certain manner. The embodiments are not limited in this context.

In various embodiments, media information may comprise image information. Image information generally may refer to any data derived from or associated with one or more static or video images. In one embodiment, for example, image information may comprise one or more pixels derived from or associated with an image, region, object, picture, video, reel, frame, clip, feed, stream, and so forth. The values assigned to pixels may comprise real numbers and/or integer numbers. The embodiments are not limited in this context.

In various embodiments, media processing node 102 may be arranged to process media information received from media source nodes 104-1-n, with n representing any positive integer. The media processing node 102 may be connected to one or more media source nodes 104-1-n through one or more wired and/or wireless communications media, as desired for a given implementation.

Media source nodes 104-1-n may comprise any media source capable of delivering media information (e.g., image information, video information, audio information, or audio/video information) to a destination node and/or to an intermediary node, such as media processing node 102.

An example of a media source may include a source for video signals, such as from a computer to a display. Other examples of a media source may include a digital camera, A/V camcorder, video surveillance system, teleconferencing system, telephone system, medical and measuring instruments, and other sources needing image and audio processing operations. Another example of a media source may include a source for audio signals. The audio source may be arranged to source or deliver standard audio information, such as analog or digital music. The embodiments are not limited in this context.

Another example of a media source may include a source for audio/video (A/V) signals such as television signals. The media source may be arranged to source or deliver standard analog television signals, digital television signals, high definition television (HDTV) signals, and so forth. The television signals may include various types of information, such as television audio information, television video information, and television control information. The television video information may include content from a video program, computer generated images (CGI), and so forth. The television audio information may include voices, music, sound effects, and so forth. The television control information may be embedded control signals to display the television video and/or audio information, commercial breaks, refresh rates, synchronization signals, and so forth. The embodiments are not limited in this context.

In some embodiments, media source nodes 104-1-n may originate from a number of different devices or networks. For example, media source nodes 104-1-n may include a device arranged to deliver pre-recorded media stored in various formats, such as a Digital Video Disc (DVD) device, a Video Home System (VHS) device, a digital VHS device, a computer, a gaming console, a Compact Disc (CD) player, and so forth. In yet another example, media source nodes 104-1-n may include media distribution systems to provide broadcast or streaming analog or digital television or audio signals to media processing node 104. Examples of media distribution systems may include, for example, Over The Air (OTA) broadcast systems, terrestrial cable systems (CATV), satellite broadcast systems, and so forth. The types and locations of media source nodes 104-1-n are not limited in this context.

In some embodiments, media source nodes 104-1-n may originate from a server connected to the media processing node 102 through a network. A server may comprise a computer or workstation, such as a web server arranged to deliver Hypertext Markup Language (HTML) or Extensible Markup Language (XML) documents via the Hypertext Transport Protocol (HTTP), for example. A network may comprise any type of data network, such as a network operating in accordance with one or more Internet protocols, such as the Transport Control Protocol (TCP) and Internet Protocol (IP). The embodiments are not limited in this context.

In various embodiments, the media processing node 102 may comprise, or be implemented as, one or more of a media processing system, a media processing sub-system, a media processor, a media computer, a media device, a media encoder, a media decoder, a media coder/decoder (CODEC), a media compression device, a media decompression device, a media filtering device (e.g., graphic scaling device, deblocking filtering device), a media transformation device a media entertainment system, a media display, or any other media processing architecture. The embodiments are not limited in this context.

In various implementations, the media processing node 102 may be arranged to perform one or more processing operations. Processing operations may generally refer to one or more operations, such as generating, managing, communicating, sending, receiving, storing forwarding, accessing, reading, writing, manipulating, encoding, decoding, compressing, decompressing, encrypting, filtering, streaming or other processing of information. The embodiments are not limited in this context.

In various embodiments, for example, the media processing node 102 may perform media processing operations such as encoding and/or compressing of media data into a file that may be stored or streamed, decoding and/or decompressing of media data from a stored file or media stream, media filtering (e.g., graphic scaling, deblocking filtering), media playback, internet-based media applications, teleconferencing applications, and streaming media applications. The embodiments are not limited in this context.

In various embodiments, the media processing node 102 may comprise multiple elements, such as element 102-1-p, where p represents any positive integer. Although FIG. 1 shows a limited number of elements by way of example, it can be appreciated that more or less elements may be used for a given implementation. The embodiments are not limited in this context.

Element 202-1-p may comprise, or be implemented as, one or more systems, sub-systems, processors, devices, machines, tools, components, circuits, registers, modules, applications, programs, subroutines, or any combination thereof, as desired for a given set of design or performance constraints. In various embodiments, element 102-1-p may be connected by one or more communications media. Communications media generally may comprise any medium capable of carrying information signals. For example, communication media may comprise wired communication media, wireless communication media, or a combination of both, as desired for a given implementation. The terms “connection” or “interconnection,” and variations thereof, in this context may refer to physical connections and/or logical connections. The embodiments are not limited in this context.

In various embodiments, the media processing node 102 may comprise a memory element 102-1. The memory element 102-1 may comprise, or be implemented as, any machine-readable or computer-readable media capable of storing data, including both volatile and non-volatile memory. For example, memory may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic disk (e.g., floppy disk and hard drive), optical disk (e.g., CD-ROM), magnetic or optical cards, or any other type of media suitable for storing information. Memory may contain various combinations of machine-readable storage devices through various I/O controllers, which are accessible by a processor and which are capable of storing a combination of computer program instructions and data. The embodiments are not limited in this context.

In various embodiments, the memory element 102-1 may be arranged to store media information, for example. In various implementations, the memory element 102-1 may be arranged to store one or more items of media information, such as one or more pixels of image information. In one embodiment, for example, one or more pixels of image information may be stored as words in memory element 102-1. A pixel generally may comprise multiple bits of information (e.g., 8 bits), and a word may have storage capacity for a certain amount of information (e.g., 32 bits or 4 pixels). Accordingly, in various embodiments, the memory element 102-1 may comprise multiple items of media information in a single word. In some implementations, multiple items of media information (e.g., pixels of image information) may correspond to a horizontal or vertical line of an image. The embodiments are not limited in this context.

In various embodiments, the memory element 102-1 may arrange media information as a two-dimensional (2D) matrix or array having N rows and M columns. Each row and column of a matrix may be arranged to store multiple words, items, and elements. In one example, a matrix may comprise 32 bit rows and 32 bit columns. Accordingly, in this example, media information may be arranged as a 4×4 matrix of 8 bit items. In another example, a matrix may comprise 64 bit rows and 64 bit columns. Accordingly, in this example, media information may be arranged as an 8×8 matrix of 8 bit items and/or as four 4×4 sub-matrixes of 8 bit items. Although described above for two dimensions, the concepts and techniques may be applied to three or more dimensions. The embodiments are not limited in this context.

In various embodiments, media information may be arranged as one or more matrices of items (e.g., pixels of image information). For example, media information may be arranged as one or more matrices. Each matrix may, in turn, comprise multiple sub-matrices. For instance, an 8×8 matrix may comprise four 4×4 sub-matrices, and a 32×32 matrix may comprise sixteen 4×4 sub-matrices. It is to be understood that the term “matrix” along with its derivatives may comprise, or be implemented, as any matrix or sub-matrix of any size. The embodiments are not limited in this context.

In various embodiments, a matrix may be addressed on a per row basis and on a per column basis. In one embodiment, a matrix may be addressed on a per row basis to comprise multiple row vectors and may be addressed on a per column basis to comprise multiple column vectors. For example, a 4×4 matrix (X_{r,c}), where r=0.3 and c=0 . . . 3, may be addressed on a per row basis to comprise X_{0,3 . . . 0} row vector, X_{1,3 . . . 0} row vector, X_{2,3 . . . 0} row vector, and X_{3,3 . . . 0} row vector. The matrix X_{r,c} may be addressed on a per column basis to comprise X_{3 . . . 0,0} column vector, X_{3 . . . 0,1} column vector, X_{3 . . . 0,2} column vector, and X_{3 . . . 0,3} column vector. In various embodiments, addressing a matrix on a per row basis and on a per column basis may be implemented in computer memory using a flip-flop based array. The embodiments are not limited in this context.

In various embodiments, media processing node 102 may comprise a processing element 102-2. The processing element 102-2 may comprise, or be implemented as one or more processors capable of providing the speed and functionality desired for an embodiment and may include accompanying architecture. The processing element 102-2 may be implemented as a general purpose processor, such as a general purpose processor made by Intel® Corporation, Santa Clara, Calif., for example. In another example, processing element 102-2 may include a dedicated processor, such as a controller, micro-controller, embedded processor, a digital signal processor (DSP), a field programmable gate array (FPGA), a programmable logic device (PLD), a network processor, an I/O processor, and so forth. In various embodiments, processing element 102-2 may comprise or be implemented as, one or more systems, sub-systems, processors, devices, machines, tools, components, circuits, registers, modules, applications, programs, subroutines, or any combination thereof. The embodiments are not limited in this context.

In various embodiments, the processing element 102-2 may comprise, or be implemented as, one or more of a media processing system, a media processing sub-system, a media processor, a media computer, a media device, a media encoder, a media decoder, a media coder/decoder (CODEC), a media compression device, a media decompression device, a media filtering device (e.g., graphic scaling device, deblocking filter, separable 2D filter), a media transform device (e.g., discrete cosine transform device, inverse discrete cosine transform device, fast Fourier transform device, inverse fast Fourier transform device), a media entertainment system, a media display, or any other media processing architecture. The embodiments are not limited in this context.

In various embodiments, the processing element 102-2 may be arranged to process media information, for example. In various implementations, the processing element 102-2 may be arranged to process one or more items of media information, such as one or more pixels of image information. In one embodiment, for example, media processing node 102 may perform processing operations on a matrix of media information, such as pixels of image information. The processing operations may be performed in a horizontal direction and in a vertical direction of the matrix. In various implementations, processing operations performed by the media processing node 102 may comprise filtering media information. For example, the media processing node 102 may perform horizontal and/or vertical filtering on one or more edges of a 4×4 pixel grid of a frame. In one embodiment, the media processing node 102 may perform filtering, such as deblocking filtering, on pixels of image information according to the ITU/IEC H.263 standard and the ITU/IEC H.264 standard. The embodiments are not limited in this context.

In various embodiments, the media processing node 102 may comprise a transposing element 102-3. The transposing element 102-3 may comprise, or be implemented as, any type of processor capable of providing the speed and functionality desired for an embodiment and may include accompanying architecture. The transposing element 102-2 may be implemented as a general purpose processor, such as a general purpose processor made by Intel® Corporation, Santa Clara, Calif., for example. In another example, transposing element 102-3 may include a dedicated processor, such as a controller, micro-controller, embedded processor, a digital signal processor (DSP), a field programmable gate array (FPGA), a programmable logic device (PLD), a network processor, an I/O processor, and so forth. In various embodiments, the transposing element 102-3 may comprise or be implemented as, one or more systems, sub-systems, processors, devices, machines, tools, components, circuits, registers, modules, applications, programs, subroutines, or any combination thereof. The embodiments are not limited in this context.

In various embodiments, the transposing element 102-3 may be arranged to access and transpose media information, for example. In various implementations, the transposing element 102-3 may access one or more items of media information, such as pixels of image information. In one embodiment, for example, the transposing element 102-3 may retrieve multiple items of media information with a single read access. The read access may be performed such that the transposing element 102-2 may access multiple items of media information in a single clock cycle. In some implementations, the accessing of media information may be performed substantially in real-time to achieve resolutions necessary for high definition television (HDTV) signals. In one example, the transposing element 102-3 may access four 8 bit pixels of image information per clock cycle. In another example, the transposing element 102-3 may access eight 8 bit pixels of image information in a single clock cycle. The embodiments are not limited in this context.

In various implementations, the transposing element 102-3 may be arranged to transpose one or more items of media information, such as pixels of image information. Transposing media information may include manipulating one or more matrices. In one embodiment, for example, the media processing node 102 may transpose one or more matrices of pixels information in order to optimize storage of media information. In one implementation, the media processing node 102 may transpose media information so that storage is optimized for filtering performed in an orthogonal direction of a matrix. The embodiments are not limited in this context.

Operations for the above systems, nodes, apparatus, elements, and/or subsystems may be further described with reference to the following figures and accompanying examples. Some of the figures may include programming logic. Although such figures presented herein may include a particular programming logic, it can be appreciated that the programming logic merely provides an example of how the general functionality as described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

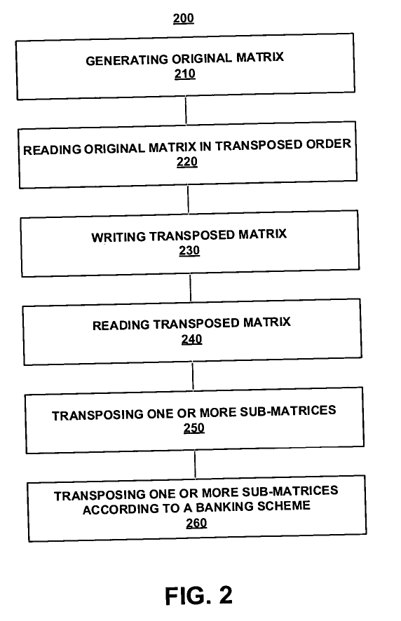

FIG. 2 illustrates a diagram of programming logic for transposing media information 200 in accordance with one embodiment. Programming logic 200 may be representative of the operations executed by one or more elements of system 100. As shown in FIG. 2, programming logic 200 may comprise generating an original matrix 210, reading an original matrix in transposed order 220, writing a transposed matrix 230, reading a transposed matrix 240, transposing one more sub-matrices 250, and transposing one or more sub-matrices according to a banking scheme 260. The embodiments are not limited in this context.

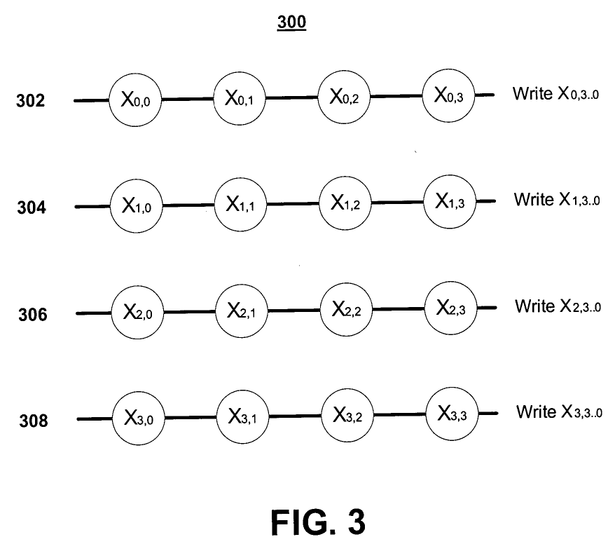

Programming logic for transposing media information 200 may comprise generating an original matrix 210. In one embodiment, for example, generating an original matrix 210 may comprise writing data on a per row basis. FIG. 3 illustrates a matrix 300 according to one embodiment. As shown, a 4×4 matrix 300 may comprise X_{0,3 . . . 0} row vector 302, X_{1,3 . . . 0} row vector 304, X_{2,3 . . . 0} row vector 306, and X_{3,3 . . . 0} row vector 308 written on a per row basis. The embodiments are not limited in this context.

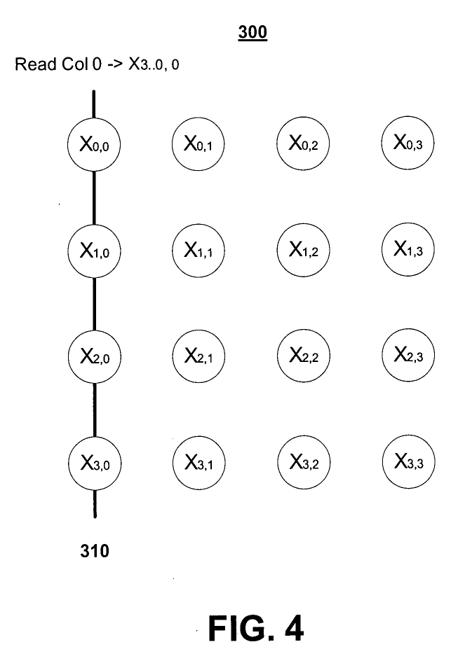

Programming logic for transposing media information 200 may comprise reading an original matrix in transposed order 220. In one embodiment, for example, reading a matrix in transposed order 220 may comprise reading column vectors of an original matrix on a per column basis. FIG. 4 illustrates a matrix 300 according to one embodiment. As shown, a 4×4 matrix 300 may comprise X_{3 . . . 0,0} column vector 310 read on a per row basis. The embodiments are not limited in this context.

Programming logic for transposing media information 200 may comprise writing a transposed matrix 230. In one embodiment, for example, writing a transposed matrix 230 may comprise writing row vectors of a transposed matrix. In various implementations, reading the original matrix on a per column basis may proceed substantially simultaneously while a new transposed matrix is written into an internal array. In one embodiment, for example, the row vector of the transposed matrix may be written in the same clock cycle in which the column vector of the original matrix is read.

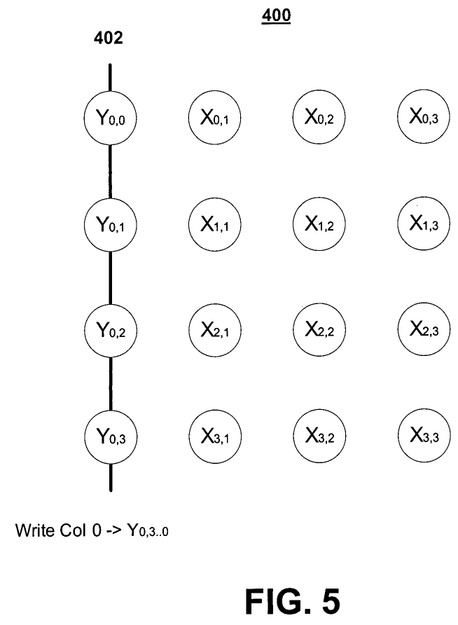

Transposing media information may comprise in-place transposition. In various embodiments, for example, a memory location of the original matrix may be written immediately after being read. For instance, writing a transposed matrix 230 may comprise writing a row vector of the transposed matrix as a column of the original matrix. FIG. 5 illustrates a transposed matrix 400 according to one embodiment. As shown, a 4×4 transposed matrix 400 may comprise row vector Y_{0,3 . . . 0} 402 written as a column of the original matrix 300 of FIG. 4. Row vector Y_{0,3 . . . 0} 402 may be written in the same clock cycle in which the column vector X_{0,3 . . . 0} 310 was read. In this embodiment, the original 4×4 matrix 300 may be transposed at a throughput of 4 pixels per cycle. The embodiments are not limited in this context.

In various implementations, performing in-place transposition may avoid the need for additional storage. For example, an original memory buffer may be re-used eliminating the need to copy media information into a secondary buffer. Transposed items of media information are not physically moved to a new transposed location. Rather, transposed items of media information may be stored in-place and address re-mapping may be employed to retrieve the transposed data. Accordingly, transposing media data may be performed with a relatively small structure, especially in cases where processing consumes input data in a sequential order. The embodiments are not limited in this context.

In various implementations, performing in-place transposition may allow media information which is to be processed together to be stored in the same words in memory. For example, pixels of image information which are to be processed together may be stored in the same word of memory. The pixels of image information may correspond to the same horizontal or vertical line, for instance. The embodiments are not limited in this context.

Programming logic for transposing media information 200 may comprise reading a transposed matrix 240. In one embodiment, for example, reading a transposed matrix 240 may comprise reading row vectors from a transposed matrix. For instance, once the row vectors of a transposed matrix are written on a per column basis, row vectors may be read to get a transposed version of the data. In various implementations, the data may comprise multiple elements such as 4 pixels of image information corresponding to the same horizontal line. The embodiments are not limited in this context.

Transposing media information may comprise alternating the direction of writing and reading for subsequent matrices or sub-matrices. In one embodiment, for example, an original matrix may be written on a per row basis and read on a per column basis to transpose data. A subsequent matrix may be written on a per column basis and read on a per row basis to transpose data. The direction of writes and reads, per column and per row, may alternate even though all vectors may be row vectors. Alternating the direction of writes and reads may allow the subsequent matrix to be written while the original matrix is being read in transposed order. The embodiments are not limited in this context.

In various implementations, transposing media data may be maintained at a high throughput based on word size. For example, a 4×4 matrix may be transposed at a high throughput of 4 pixels per clock cycle after an initial latency of 4 cycles. In various embodiments, the throughput of transposing may be the same as the throughput of processing the media information. For example, transposing media information in a second direction (e.g., orthogonal direction) may be performed as soon as processing in a first direction has been completed. For instance, horizontal filtering may be performed immediately after vertical filtering is complete. The embodiments are not limited in this context.

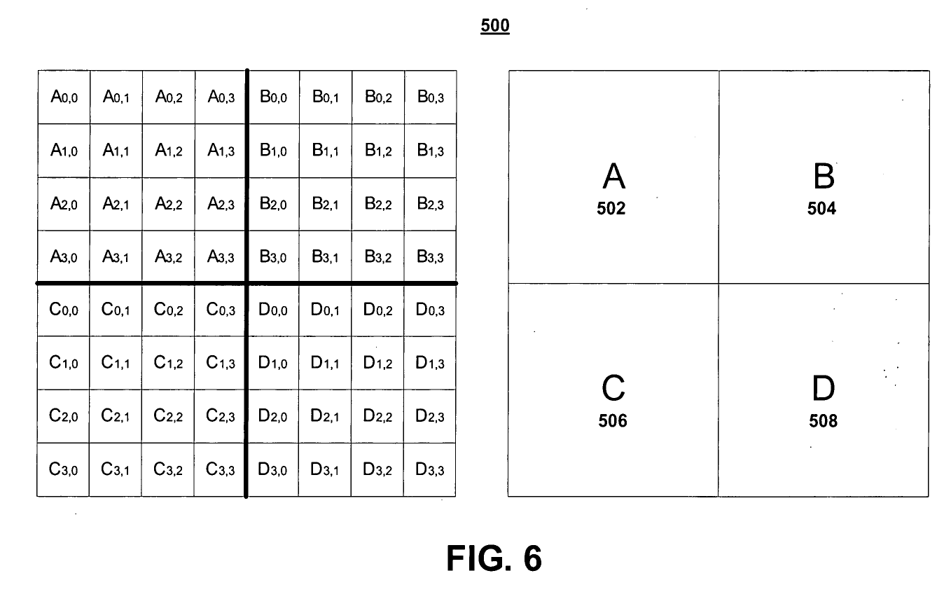

Programming logic for transposing media information 200 may comprise transposing one or more sub-matrices 250. In one embodiment, for example, media information (e.g., pixels of image information) may be arranged as a matrix comprising multiple sub-matrices. For instance, an 8×8 matrix may comprise four 4×4 sub-matrices, and a 32×32 matrix may comprise sixteen sub-matrices. FIG. 6 illustrates a matrix 500 according to one embodiment. The matrix 500 may comprise an 8×8 matrix of 8 bit pixels. The matrix 500 may comprise a 4×4 sub-matrix A 502, a 4×4 sub-matrix B 504, a 4×4 sub-matrix C 506, and a 4×4 sub-matrix D 508. Each of the sub-matrices may comprise a 4×4 sub-matrix of 8 bit pixels. A 32 bit word in computer memory may store four 8 bit pixels. The embodiments are not limited in this context.

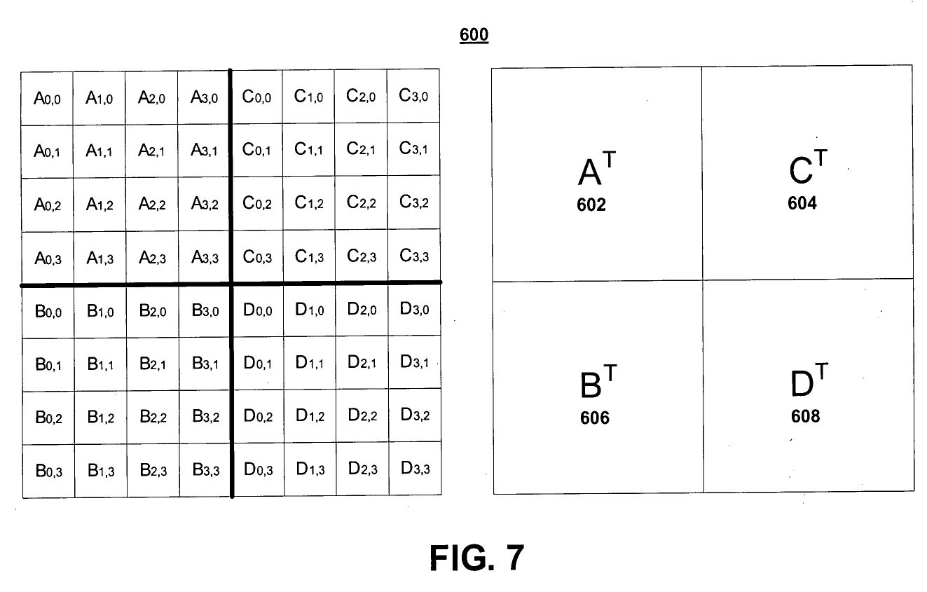

In various embodiments, individually transposing one or more sub-matrices 250 may effectuate the transposition of an overall matrix. FIG. 7 illustrates a transposed matrix 600 according to one embodiment. As shown, a transposed 8×8 matrix 600 may comprise a transposed 4×4 sub-matrix A^{T} 602, a transposed 4×4 sub-matrix C^{T} 604, a transposed 4×4 sub-matrix B^{T} 606, and a transposed 4×4 sub-matrix D^{T} 608. The embodiments are not limited in this context.

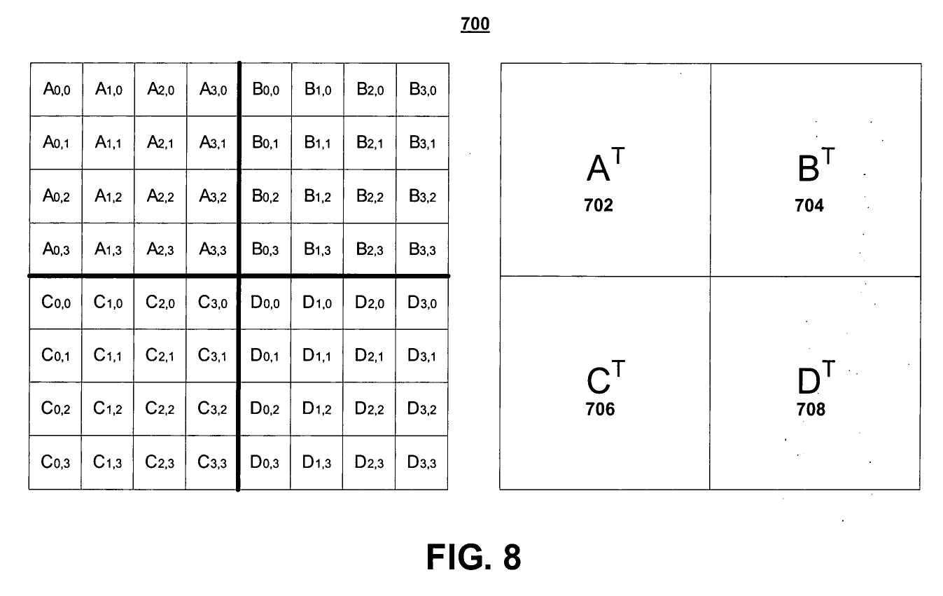

Transposing one or more sub-matrices 250 may comprise performing in-place transposition. In one embodiment, for example, an original memory location of a sub-matrix may be written immediately after being read. FIG. 8 illustrates a transposed matrix 700 according to one embodiment. The transposed matrix 700 may comprise an 8×8 matrix of 8 bit pixels. The transposed matrix 700 may comprise a transposed 4×4 sub-matrix A^{T} 702, a transposed 4×4 sub-matrix B^{T} 704, a transposed 4×4 sub-matrix C^{T} 706, and a transposed 4×4 sub-matrix D^{T} 708. In various implementations, the transposed sub-matrix B^{T} 704 may be stored in the same memory location as the sub-matrix B 504 in the original matrix 500 of FIG. 6. The embodiments are not limited in this context.

Transposing one or more sub-matrixes 250 may comprise performing low-level transposing and high-level transposing. In one embodiment, for example, low-level physical transposition of individual sub-matrices may be performed in-place while high-level transposition of one or more sub-matrices may be performed in the logical domain. For example, high-level transposition may be performed on the transposed matrix 700 of FIG. 8 to logically result in the transposed matrix 600 of FIG. 7. In various implementations, high-level transposition of sub-matrices in the logical domain may be effectuated by remapping addresses (e.g., X,Y coordinates) of the sub-matrices in computer memory. Performing “on-the-fly” remapping original 2D addresses of 4×4 sub-matrices may provide access to all items in an original 8×8 matrix at a rate of 4 pixels per clock cycle. Accordingly, a limited size structure may be used to transpose a matrix of any size. The embodiments are not limited in this context

Programming logic for transposing media information 200 may comprise transposing sub-matrices according to a memory banking scheme 260. In various embodiments, a memory banking scheme may comprise mapping words to different memory banks in computer memory. The memory banking scheme may allow sub-matrices within a matrix to be physically transposed in smaller size units, such as in 4×4 blocks, for example. The embodiments are not limited in this context.

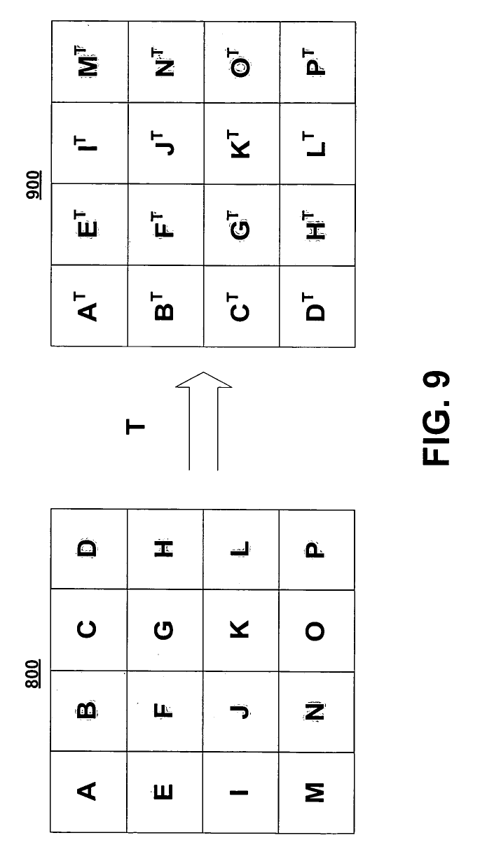

FIG. 9 illustrates an original matrix 800 and a transposed matrix 900 according to one embodiment. The original matrix 800 and the transposed matrix 900 each may comprise a 32×32 matrix of 8 bit pixels. The original matrix 800 may comprise 4×4 sub-matrices of 8 bit pixels A-P, and the transposed matrix 900 may comprise 4×4 sub-matrices A^{T}-P^{T}. In various embodiments, a memory banking scheme may comprise a “natural” mapping scheme in which each alternate 32 bit word is mapped to a different memory bank. As shown, white blocks may correspond to Bank #0, and dark blocks may correspond to Bank #1, for example. The embodiments are not limited in this context.

In various implementations, physical transposition of sub-matrices may be performed. Referring again to FIG. 9, for example, physically transposing sub-matrices in transposed matrix 900 may be necessary in order to access data in sub-matrix A^{T} and data in sub-matrix E^{T} simultaneously. The embodiments are not limited in this context.

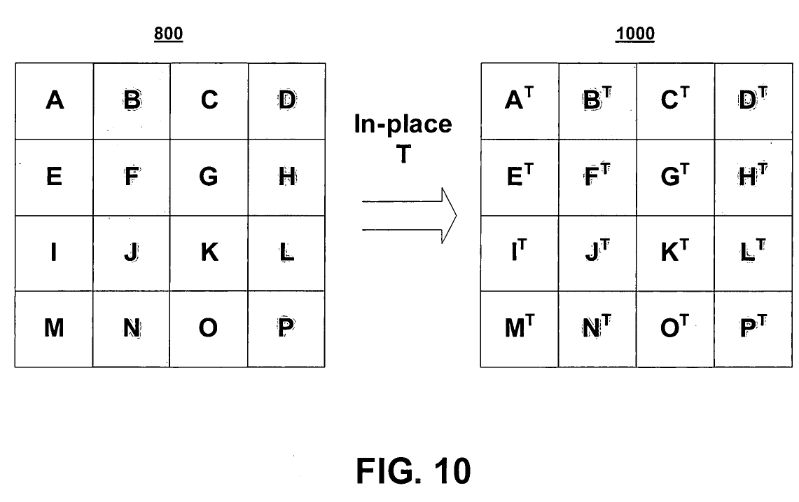

In various embodiments, transposing sub-matrices according to a memory banking scheme 260 may comprise performing in-place transposition. For example, an original matrix may be transposed by physically transposing each sub-matrix in-place. FIG. 10 illustrates an original matrix 800 and a transposed matrix 1000 according to one embodiment. The transposed matrix 1000 may comprise a 32×32 matrix of 8 bit pixels. The transposed matrix 1000 may comprise 4×4 sub-matrices A^{T}-P^{T} which are physically transposed in-place. As shown, white blocks may correspond to Bank #0 and dark blocks may correspond to Bank #1 according to a “natural” mapping scheme in which each alternate 32 bit word is mapped to a different bank. The embodiments are not limited in this context.

Referring again to FIG. 10, in various embodiments, employing a “natural” mapping scheme in conjunction with in-place transposition may result in A^{T} and E^{T} pixels residing in the same physical memory bank. Because A^{T} and E^{T} may not be accessed simultaneously, two clock cycles may be required to fetch a pair of 32 bit words comprising 8 pixels. The embodiments are not limited in this context.

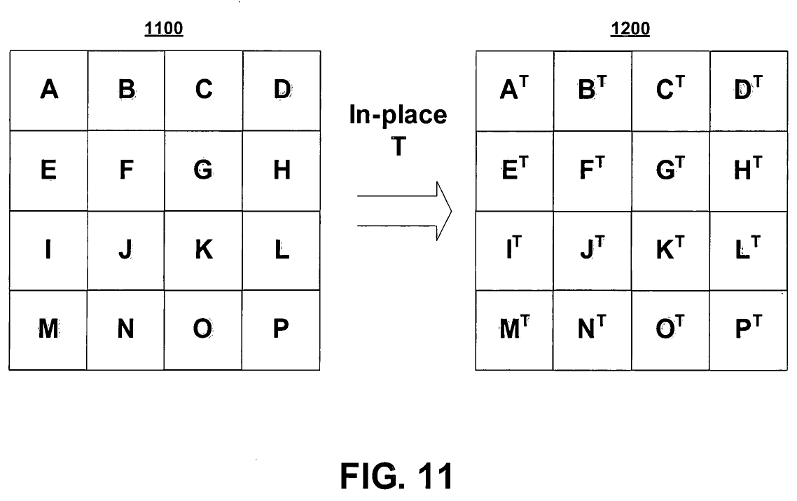

In various embodiments, a memory banking scheme may comprise a “check-board” mapping scheme for mapping words to different memory banks. FIG. 11 illustrates an original matrix 1100 and a transposed matrix 1200 according to one embodiment. The transposed matrix 1200 may comprise a 32×32 matrix of 8 bit pixels. The transposed matrix 1200 may comprise 4×4 sub-matrices A^{T}-P^{T} which are physically transposed in-place. As shown, white blocks may correspond to Bank #0 and dark blocks may correspond to Bank #1 according to a “check-board” mapping scheme in which transposed sub-matrices do not switch memory banks. The embodiments are not limited in this context.

Referring again to FIG. 11, in various implementations, employing a “check-board” mapping scheme in conjunction with in-place transposition may result in A^{T} and E^{T} pixels residing in different physical memory banks. Because A^{T} and E^{T} may be accessed simultaneously, a pair of 32 bit words comprising 8 pixels may be fetched in a single clock cycle. The embodiments are not limited in this context.

In various embodiments, transposing sub-matrices according to a memory banking scheme 260 may comprise logically remapping addresses (e.g., X,Y coordinates) of sub-matrices in computer memory. In various implementations, a 4×4 temporary array may be sufficient to perform in-place transposition of a matrix stored in memory, while maintaining an access rate to the memory in both directions of 8 pixels per cycle. The embodiments are not limited in this context.

In various embodiments, transposition may allow the rate at which pixels are processed to be maintained. For example, media information (e.g., pixels of image information) may be accessed from memory at a rate of 4 pixels per cycle and transposed a rate of 4 pixels per cycle. When media processing (e.g., filtering) is performed in the horizontal direction and in the vertical direction, the same access speed may be achieved when processing in the opposite direction for which the storage was optimized. Accordingly, processing in an orthogonal direction may take advantage of “multiple pixels per word” organization in memory. The embodiments are not limited in this context.

In various implementations, transposition may allow high throughput operations to be performed with minimal effect on performance. For example, in-place transposition may be relatively non-intrusive and, in many cases, may be fully non-intrusive with respect to processing performed on the original media information. In various embodiments, in-place transposition may commence before first pass processing is complete. For example, when processing such as vertical filtering is being performed, the transposition operation may be performed on pixels as they are processed so that data is available when horizontal filtering starts. The embodiments are not limited in this context.

In various embodiments, transposition may substantially reduce resource requirements, reduce gate count, and increase performance over traditional media processing approaches. For example, writing transposed media information in an original memory buffer may avoid the need for extra storage. In addition, transposition may be compatible with one or more banked memory schemes for increased throughput without increasing temporary array size. In some implementations, eliminating the need for an extra memory buffer to store transposed matrices may reduce memory requirements by half when performing 2D graphical operations. Accordingly, transposition may reduce costs while meeting performance with lower area resources. The embodiments are not limited in this context.

Although described above for two dimensions, the media processing techniques, described herein, may be applied to three or more dimensions. The media processing techniques may be applied to memories with any word size and to any other operation involving matrix transposition. Examples of operations include, but are not limited to, discrete cosine transform (DCT) calculation, inverse discrete cosine transform (iDCT) calculation, and digital zooming as separable horizontal and vertical direction filters. In various implementations, the media processing techniques described above may be applied to any operation involving transposing an organized set of data to allow processing with high throughput in the complementary direction. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although a system may be illustrated using a particular communications media by way of example, it may be appreciated that the principles and techniques discussed herein may be implemented using any type of communication media and accompanying technology. For example, a system may be implemented as a wired communication system, a wireless communication system, or a combination of both.

When implemented as a wireless system, for example, a system may include one or more wireless nodes arranged to communicate information over one or more types of wireless communication media. An example of a wireless communication media may include portions of a wireless spectrum, such as the radio-frequency (RF) spectrum radio frequencies (RF) and so forth. The wireless nodes may include components and interfaces suitable for communicating information signals over the designated wireless spectrum, such as one or more antennas, wireless transmitters/receivers (“transceivers”), amplifiers, filters, control logic, and so forth. As used herein, the term “transceiver” may be used in a very general sense to include a transmitter, a receiver, or a combination of both. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

When implemented as a wired system, for example, a system may include one or more nodes arranged to communicate information over one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a media processing node to process media information, the media processing node comprising:
a memory to store said media information as a matrix of items of media information; and
a transposing element to transpose said items of media information and storing transposed items of media information in said memory.

2. The apparatus of claim 1, wherein said memory is to store multiple items of media information as a word.

3. The apparatus of claim 1, wherein said transposing element is to write said transposed items of media information to at least one of a row and a column of said matrix.

4. The apparatus of claim 1, wherein said matrix comprises a multiple sub-matrices.

5. The apparatus of claim 1, further comprising:
a processing element to perform at least one of horizontal processing and vertical processing on said items of media information.

6. A system, comprising:
a media source node to provide media information; and
a media processing node to process media information received from said media source node, the media processing node comprising:
a memory to store said media information as a matrix of items of media information; and
a transposing element to transpose said items of media information and to store transposed items of media information in said memory.

7. The system of claim 6, wherein said memory is to store multiple items of media information as a word.

8. The system of claim 6, wherein said transposing element is to write said transposed items of media information to at least one of a row and a column of said matrix.

9. The system of claim 6, wherein said matrix comprises multiple sub-matrices.

10. The system of claim 6, further comprising:
a processing element to perform at least one of horizontal processing and vertical processing on said items of media information.

11. A method, comprising:
storing media information in memory as a matrix of items of media information;
transposing said items of media information; and
storing transposed items of media information in said memory.

12. The method of claim 11, further comprising storing multiple items of media information as a word.

13. The method of claim 11, further comprising writing said transposed items of media information to at least one of a row and a column of said matrix.

14. The method of claim 11, further comprising transposing multiple sub-matrices of said matrix.

15. The method of claim 11, further comprising performing at least one of horizontal processing and vertical processing on said items of media information.

16. An article comprising a machine-readable storage medium containing instructions that if executed enable a system to:
store media information in memory as a matrix of items of media information;
transpose said items of media information; and
store transposed items of media information in said memory.

17. The article of claim 16, further comprising instructions that if executed enable the system to store multiple items of media information as a word.

18. The article of claim 16, further comprising instructions that if executed enable the system to write said transposed items of media information to at least one of a row and a column of said matrix.

19. The article of claim 16, further comprising instructions that if executed enable the system to transpose multiple sub-matrices of said matrix.

20. The article of claim 16, further comprising instructions that if executed enable the system to perform at least one of horizontal processing and vertical processing on said items of media information.
